(19) United States
(12) Patent Application Publication
(10) Pub. No.: US 2002/0196836 A1
(43) Pub. Date: Dec. 26, 2002

(54) Emission monitoring system probe assembly for high-temperature applications

(76) Inventors: Stephen T. Staphanos, Long Beach, CA (US); Marion A. Keyes, St. Louis, MO (US)

Correspondence Address: WESTMAN, CHAMPLIN & KELLY, A PROFESSIONAL ASSOCIATION, INTERNATIONAL CENTRE - SUITE 1600, 900 SECOND AVENUE SOUTH, MINNEAPOLIS, MN, 55402-3319, US

(21) Appl. No.: 10/171,413

(22) Filed: Jun. 13, 2002

Related U.S. Application Data
(60) Provisional application No. 60/300,229, filed on Jun. 22, 2001.

(51) Int. Cl. G01K 13/00

(52) U.S. Cl. 374/141

(57) ABSTRACT

A high-temperature probe assembly for a continuous emission monitoring system is provided. The probe assembly includes a sample take-off coupled to a sample source. A length of high-temperature conduit is coupled to the sample take-off. The length of high-temperature conduit is also coupled to a chamber that includes an upper portion disposed above a focussing portion. The focussing portion is shaped to guide matter falling thereon to a drain. A sample probe is disposed within the chamber proximate the upper portion. A method for obtaining a high-temperature sample is also provided.

### BACKGROUND OF THE INVENTION

The present invention relates to continuous emission monitoring systems. More specifically, the present invention relates to a sample probe assembly for a continuous emission monitoring system that is particularly adapted for high-temperature applications.

A number of industrial operations include very high-temperature processes. Examples of such applications are glass furnaces; coking ovens; catalytic crackers; utility coal pulverizes; and industrial incinerator stacks. Generally, such industrial processes are governed by applicable environmental regulations promulgated by appropriate authorities, such as the Environmental Protection Agency in the United States. Such regulations generally set forth acceptable levels of pollutants that can be released to the environment from such industrial processes. In order to ensure compliance with such regulations, emission monitoring systems, and in particular continuous emission monitoring systems are often used. Such systems continuously divert a small amount of the exhaust gases into a sample handling system where the sample is preliminarily prepared, and provided to a suitable analyzer to provide data indicative of the qualitative, and/or quantitative nature of the specific pollutants within the exhaust.

A difficulty arises in high-temperature applications because the sample that must be diverted from the exhaust is at such a high initial temperature that it could seriously harm or otherwise deteriorate the sample handling system itself. Moreover, the high-temperature sample may also include liquids and solids that would clog, or otherwise occlude the sample handling system.

### SUMMARY OF THE INVENTION

A high-temperature probe assembly for a continuous emission monitoring system is provided. The probe assembly includes a sample take-off coupled to a sample source. A length of high-temperature conduit is coupled to the sample take-off. The length of high-temperature conduit is also coupled to a chamber that includes an upper portion disposed above a focussing portion. The focussing portion is shaped to guide matter falling thereon to a drain. A sample probe is disposed within the chamber proximate the upper portion. A method for obtaining a high-temperature sample is also provided.

### BRIEF DESCRIPTION OF THE DRAWINGS

FIG. 1 is a diagrammatic view of a portion of a continuous emission monitoring system in accordance with an embodiment of the present invention.

### DETAILED DESCRIPTION OF THE PREFERRED EMBODIMENTS

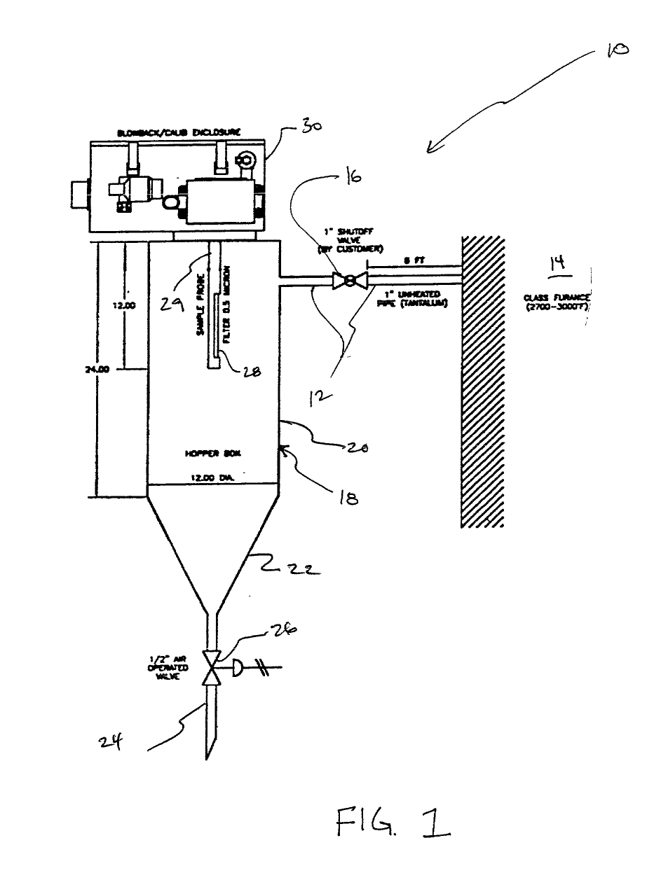

FIG. 1 is a diagrammatic view of a portion of a continuous emission monitoring system in accordance with an embodiment of the present invention. Portion 10 includes a quantity of high-temperature compatible conduit 12 coupled to emission source 14 (in this example emission source 14 is a “glass furnace” operating between 2700° and 3000° F.). Conduit 12 is constructed from a high-temperature material such as tantalum. However, conduit 12 can also be constructed from other high-temperature materials, such as ceramics. In one embodiment, illustrated in FIG. 1, a shut-off valve is interposed serially along conduit 12 to inhibit sample flow into chamber 18. Preferably, valve 16 is selected for high-temperature compatibility.

The sample is thus conveyed from glass furnace 14 through conduit 12 and into chamber 18. Chamber 18 includes an upper portion 20 disposed above a focussing portion 22, which portion 22 is shaped to guide matter falling thereon to drain 24. In some embodiments chamber 18 is a hopper and will be referred to as such, although the invention is not limited to chamber 18 being a hopper. Sample entering hopper 18 through conduit 12 is allowed to expand and cool. Generally, particulate matter will fall to focussing portion 22 and ultimately pass through drain 24 when valve 26 (which is preferably air operated) is actuated. Additionally, condensate or other undesirable liquids also fall into conical portion 22 and pass out drain 24. The gaseous sample of interest, then, is left in portion 20 and passes through filter 28. Preferably, filter 28 is a Motts filter element, 0.5 micron filter that removes additional particulates and other undesirable material that may not have fallen into conical portion 22. Thus, the sample passes through filter 28, into probe 29 and on into blow-back/calibration enclosure 30 which further prepares the sample in accordance with known sample handling techniques and conveys it to a suitable analyzer to provide an output.

Preferably, hopper 18 is positioned approximately 2 to 3 meters from sample take-off point 19 thereby allowing the sample to cool as it passes through the length of conduit 12. For example, for a glass furnace operating between 2700° and 3000° F., conduit 12 can allow the sample to cool to temperatures below 2000° F. Hopper 18 can also be constructed from any suitable material such as 316 stainless steel. As the sample passes into hopper 18, it is separated such that gaseous sample is conveyed further to filter 28 and on into sample probe 29 while liquids and solids fall into conical portion 22 and pass out drain 24. Additionally, suitable actuation and connections can be provided to drain 24 to not only provide for automatic draining, but also blow-back functions.

In summary, the probe assembly in accordance with embodiments of the present invention allows continuous emission monitoring to be performed on emission sources that operate at temperatures which prohibited such monitoring in the past. Thus, additional emission sources can now be operated more effectively and in compliance with applicable environmental regulations utilizing a relatively simple sample handling system and probe assembly.

Although the present invention has been described with reference to preferred embodiments, workers skilled in the art will recognize that changes may be made in form and detail without departing from the spirit and scope of the invention.

What is claimed is:

1. A high-temperature probe assembly for an emission monitoring system, the assembly comprising:
a length of high-temperature conduit coupleable to a sample take-off;
a chamber coupled to the length of high-temperature conduit, the chamber having an upper portion disposed above a focussing portion, which focussing portion is shaped to guide matter falling thereon to a drain; and
a sample probe disposed within the chamber proximate the upper portion.

2. The probe assembly of claim 1 wherein the length of high-temperature conduit is formed of tantalum.

3. The probe assembly of claim 1 wherein the chamber is a hopper.

4. The probe assembly of claim 3 wherein the upper portion is cylindrical.

5. The probe assembly of claim 3 wherein the focussing portion is conical.

6. The probe assembly of claim 1 and further comprising a valve interposed along the length of high-temperature conduit.

7. The probe assembly of claim 1 and further comprising a filter element coupled to the sample probe.

8. The probe assembly of claim 7 wherein the filter element includes a 0.5 micron filter.

9. The probe assembly of claim 1 and further comprising a solenoid valve coupled to the drain.

10. The probe assembly of claim 9 wherein the solenoid valve is automatically driven to periodically drain the matter from the chamber.

11. The probe assembly of claim 1 wherein the length of high-temperature conduit is approximately between 2 and 3 meters long.

12. A method of obtaining a sample from a high-temperature sample source, the method comprising:
coupling a length of high-temperature conduit to the sample source to remove a portion of sample from the sample source;
passing the sample through the length of high-temperature sample source into a chamber;
allowing gravity to separate solid and liquid matter from gasses in the sample; and
conveying the gaseous portion of the sample into a sample probe disposed within the chamber.

13. The method of claim 12 and further comprising draining the liquid and solid matter from the chamber.

14. The method of claim 13 wherein the step of draining is performed periodically automatically.

15. The method of claim 12 wherein the step of conveying the sample through the length of high-temperature conduit includes allowing the sample to cool by at least 600° C.
